(19) United States
(12) Patent Application Publication
(10) Pub. No.: US 2017/0082499 A1
(43) Pub. Date: Mar. 23, 2017

(54) TEMPERATURE TAGS AND METHODS FOR THEIR PREPARATION AND USE

(71) Applicant: Empire Technology Development LLC, Wilmington, DE (US)

(72) Inventor: Yasuhisa Fujii, Kyoto (JP)

(21) Appl. No.: 14/862,074

(22) Filed: Sep. 22, 2015

(51) Int. Cl. G01K 5/48; G01K 3/04

(52) U.S. Cl. CPC G01K 5/483; G01K 3/04

(57) ABSTRACT

A temperature tag and methods of making and using the same are disclosed. The temperature tag includes one or more cantilevers, each having at least one end attached to a substrate, wherein the cantilever includes a shape memory material having at least one transformation temperature, and the cantilever is configured to transform in shape when exposed to a temperature equal to or above the at least one transformation temperature. Methods of preparing and using the temperature tag are also disclosed.

### FIELD

The present disclosure relates to temperature tags and methods of making and using the same.

### BACKGROUND

During storage, handling and transportation, products may be exposed to environmental conditions that can potentially cause damage to them. For example, temperature sensitive products, such as pharmaceutical drugs, perishable food items and electronic devices, can be damaged when they are exposed to high temperatures. Information about environmental conditions to which the products have been exposed will therefore be useful to monitor the condition of the products. Electronic systems that log temperatures over time have been used to monitor temperature history, but such systems are generally expensive and require active data storage, calibration and training for the intended user. A simple and cost-effective device that can record temperature history would therefore be desirable.

### SUMMARY

In some embodiments, a temperature tag includes:

one or more cantilevers, each having at least one end attached to a substrate,

wherein the cantilever includes a shape memory material having at least one transformation temperature, and the cantilever is configured to transform in shape when exposed to a temperature equal to or above the at least one transformation temperature.

In some embodiments, a method of making a temperature tag includes:

depositing a layer of shape memory material on a surface of a substrate, the layer of shape memory material having a graded composition along a length, a breadth, a diagonal, or a combination thereof, of the substrate; and

removing one or more portions of the substrate to expose one or more portions of the layer of shape memory material, wherein exposed one or more portions of the shape memory material form one or more cantilevers, each cantilever extending from an unremoved portion of the substrate.

In some embodiments, a method of making a temperature tag includes:

depositing a layer of shape memory material on a surface of a substrate;

annealing at least two portions of the layer of shape memory material under different conditions so that at least two portions of the layer of shape memory material have different transformation temperatures; and

removing one or more portions of the substrate underlying annealed portions of the layer of shape memory material, such that the annealed portions form one or more cantilevers, each cantilever extending from an unremoved portion of the substrate.

In some embodiments, a method of preparing a layer of shape memory material includes:

depositing two or more sub-layers of components on a substrate to form the layer of shape memory material, each of the two or more sub-layers having different components;

wherein at least one of the two or more sub-layers has a graded thickness along a length, a breadth, a diagonal, or a combination thereof, of the substrate

In some embodiments, a method of preparing a layer of shape memory material includes:

depositing two or more sub-layers of components on a substrate to form the layer of shape memory material, each of the two or more sub-layers having different components; and

annealing at least two portions of the layer of shape memory material under different conditions so that at least two portions of the layer of shape memory material have different transformation temperatures.

In some embodiments, a method of using a temperature tag includes:

attaching the temperature tag to an object, the temperature tag including one or more cantilevers, each having at least one end attached to a substrate, wherein the cantilever comprises a shape memory material having at least one transformation temperature, and the cantilever is configured to transform in shape when exposed to a temperature above, equal to, or below the at least one transformation temperature; and

reading the temperature tag after a period of time to determine if the object has been exposed to a predetermined temperature associated with each cantilever, the predetermined temperature being equal to or above the at least one transformation temperature of that cantilever.

### BRIEF DESCRIPTION OF THE DRAWINGS

FIGS. 1A to 1C show a temperature tag having two cantilevers in accordance with some embodiments. FIG. 1A shows the temperature tag at an initial state before use. FIGS. 1B and 1C show the temperature tag after exposures to temperatures above the transformation temperatures of one or both of the cantilevers.

FIGS. 2A to 2C show another temperature tag having two cantilevers, each configured with a film component layer and a piezoelectric element, in accordance with some embodiments. FIG. 2A shows the temperature tag at an initial state before use. FIGS. 2B and 2C show the temperature tag after exposures to temperatures above the transformation temperatures of one or both of the cantilevers.

FIG. 3 shows a top view of a layer of Ti—Ni—Zr shape memory material on a substrate, in accordance with some embodiments.

FIGS. 4A to 4C show a side view of the substrate-supported shape memory material of FIG. 3, at various stages of material deposition in accordance with some embodiments. FIG. 4A shows a side view of the substrate after depositing a Ti sub-layer. FIG. 4B shows a side view of the substrate after depositing the Ti sub-layer and the Ni sub-layer. FIG. 4C shows a side view of the substrate after depositing multiple layers of Ti sub-layer, Ni sub-layer and Zr sub-layer.

FIG. 5 shows a substrate supported shape memory material having Parts A to G configured with different compositions of Ti, Ni and Zr in accordance with some embodiments.

FIGS. 6A to 6D show a temperature tag at various stages of making in accordance with some embodiments.

FIGS. 7A to 7G show a temperature tag at various stages of making in accordance with some embodiments.

### DETAILED DESCRIPTION

Disclosed herein, among other things, are temperature tags and methods of making and using the temperature tags. The temperature tags can detect exposures to temperatures equal to or above one or more predetermined temperatures, and can record a history of different temperatures to which the tags have been exposed.

### Temperature Tags

A temperature tag may include one or more cantilevers, each having at least one end attached to a substrate. Each cantilever may include a shape memory material having at least one transformation temperature, and can be configured to transform in shape when exposed to a temperature equal to or above the at least one transformation temperature.

Shape memory materials can generally “remember” its original shape after they have been deformed. When an external stimulus is applied to a deformed shape memory material, the deformed shape memory material can return to its original shape. The external stimulus can be in the form of a temperature change, such as heat. The shape memory material can be a shape memory alloy.

Shape memory alloys typically have a martensite phase and an austenite phase. The martensite phase generally exists at lower temperatures, and the austenite phase generally exists at higher temperatures. The shape memory alloy is usually hard and rigid in the austenite phase, and soft and flexible in the martensite phase. As such, the shape memory alloy can be deformed (for example, bent or stretched) in the martensite phase, and retain the deformed state until it is heated to form the austenite phase. When in the austenite phase, the shape memory alloy returns to its original shape or pre-deformed state. As the shape memory alloy cools, it transitions from the austenite phase to the martensite phase. The shape memory alloy generally remains in its original shape during the transition from the austenite phase to the martensite phase, unless an external force is available to deform the shape memory alloy when it returns to the martensite phase. One example of the external force is the compressive force exerted by a film component layer attached to the shape memory alloy, as will be described below.

The shape memory alloy has a martensite transformation temperature and an austenite transformation temperature. The martensite transformation temperature and the austenite transformation temperature are not usually the same. That is, the temperature at which the shape memory material transitions from the martensite phase to the austenite phase during heating, and the temperature at which the shape memory material transitions from the austenite phase to the martensite phase during cooling, are generally different.

In some embodiments, the at least one transformation temperature includes an austenite transformation temperature and a martensite transformation temperature, and the austenite transformation temperature is higher than the martensite transformation temperature. In some embodiments, the cantilever transforms from a first shape to a second shape after exposure to a temperature equal to or above the austenite transformation temperature, and the cantilever remains in the second shape when the temperature is below the austenite transformation temperature. The cantilever may continue to remain in the second shape when the temperature cools to the martensite transformation temperature or below.

In some embodiments, the first shape is a curved shape and the second shape is a straight shape. For example, the shape memory material can be configured to have a first shape in the martensite phase and a second shape in the austenite phase. At an initial stage, the shape memory material can be in the martensite phase and may be deformed to form a curved shape (first shape). As the deformed shape memory material is heated to a temperature equal to or above the austenite transformation temperature, it can transform from the curved shape (first shape) to its original shape or straight shape (second shape). As the shape memory material cools to a temperature below the austenite transformation temperature, the shape memory material may remain in the straight shape (second shape). The shape memory material may continue to remain in the straight shape as it cools further to the martensite transformation temperature or lower.

In some embodiments, the shape memory material in at least two cantilevers have the same composition. In some embodiments, the shape memory material in at least two cantilevers have different compositions. The composition of the shape memory material may affect its transformation temperature such as the austenite transformation temperature and the martensite transformation temperature. For example, in Ti—Ni shape memory alloys, increasing the amount of Ni in the alloy may decrease the martensite transformation temperature. Also, in Ti—Ni—Zr shape memory alloys, increasing the amount of Zr in the alloy may increase the austenite transformation temperature.

In some embodiments, the shape memory material in the at least two cantilevers have the same austenite transformation temperature, martensite transformation temperature, or both. In some embodiments, the shape memory material in the at least two cantilevers have different austenite transformation temperatures, martensite transformation temperatures, or both. In some embodiments, the at least two cantilevers may be arranged in an array on the substrate.

The temperature tag described herein can further include a film component layer on a surface of the cantilever facing the substrate, wherein the film component layer applies a compressive force to bias the cantilever in the first shape. The compressive force exerted by the film component layer on the cantilever can deform the shape memory material when it is in the martensite phase. As the shape memory material transitions from the martensite phase to the austenite phase, the shape memory material can overcome the compressive force to restore its pre-deformed state. Therefore, for a cantilever formed with the film component layer, the cantilever may be deformed by the compressive force of the film component layer to form a curved shape (first shape) in the martensite phase. As the deformed shape memory material is heated to a temperature equal to or above the austenite transformation temperature, it can transform from the curved shape (first shape) to its original shape or straight shape (second shape) by overcoming the compressive force of the film component layer. As the shape memory material cools to a temperature below the austenite transformation temperature, the shape memory material may remain in the straight shape (second shape) until it cools to slightly above the martensite transformation temperature. When the shape memory material cools further to the martensite transformation temperature or lower, it transitions to the martensite phase and becomes deformed by the compressive force exerted by the film component layer. The deformed cantilever can then undergo the same transformations as described above when exposed to temperature changes.

In some embodiments, the film component is is an oxide film. In some embodiments, the oxide film includes silicon dioxide, tetraethylorthosilicate (TEOS) oxide, or any combination thereof.

The temperature tag described herein can further include a piezoelectric element on a surface of the cantilever opposite the substrate, the piezoelectric element overlying the end of the cantilever that is attached to the substrate and a portion of the cantilever extending from the end. In some embodiments, the piezoelectric element is PVDF (polyvinylidene difluoride), BaTiO₃, PbPO₃, KNbO₃, LiNbO₃, LiTiO₃, LiTaO₃, Ba₂NaNb₅O₅, Pb₂KNb₅O₁₅, AlN, PZT (lead zirconate titanate), ZnO, or any combination thereof. When the cantilever transforms from the first shape to the second shape or vice versa during temperature fluctuations, the shape transformation exerts a tensile stress on the piezoelectric element in the longitudinal direction, thereby allowing sensing of the shape transformation, and hence exposure of the temperature tag to a temperature equal to or above the transformation temperature of the cantilever. The shape transformations can be sensed by the piezoelectric element in real-time, thus allowing real-time detection of exposures to one or more temperatures equal to or above the transformation temperature of each cantilever.

In some embodiments, the shape memory material is a shape memory alloy. In some embodiments, the shape memory alloy includes at least two metals. In some embodiments, the shape memory alloy is AgCd, AuCd, CuSn, CuZn, InTl, NiAl, TiNi, TiPd, FePt, FePd, MnCu, Cu—Al—Ni, Cu—Au—Zn, Cu—Zn—Si, Cu—Zn—Sn, Cu—Zn—Al, Cu—Zn—Ga, Ti—Ni—Zr, Ni—Mn—Al, Cu—Al—Mn, Fe—Mn—Si, Fe—Ti—Ni, Ti—Nb—Ta, Ti—Ni—Zr—Nb, or any combination thereof.

In some embodiments, the substrate includes silicon. The substrate may also include other materials capable of providing structural support to the cantilevers.

The austenite transformation temperature of the shape memory material can vary depending on the type of the shape memory material and the composition of the shape memory material. In some embodiments, the austenite transformation temperature of the shape memory material is about −70° C. to about 880° C. For example, the austenite transformation temperature of the shape memory material is about −70° C., about −50° C., about 0° C., about 50° C., about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., about 880° C. or a temperature between any two of these values.

The martensite transformation temperature of the shape memory material can also vary depending on the type of the shape memory material and the composition of the shape memory material. In some embodiments, the martensite transformation temperature of the shape memory material is about −100° C. to about 850° C. For example, the martensite transformation temperature of the shape memory material is about −100° C., about −50° C., about 0° C., about 50° C., about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., or a temperature between any two of these values.

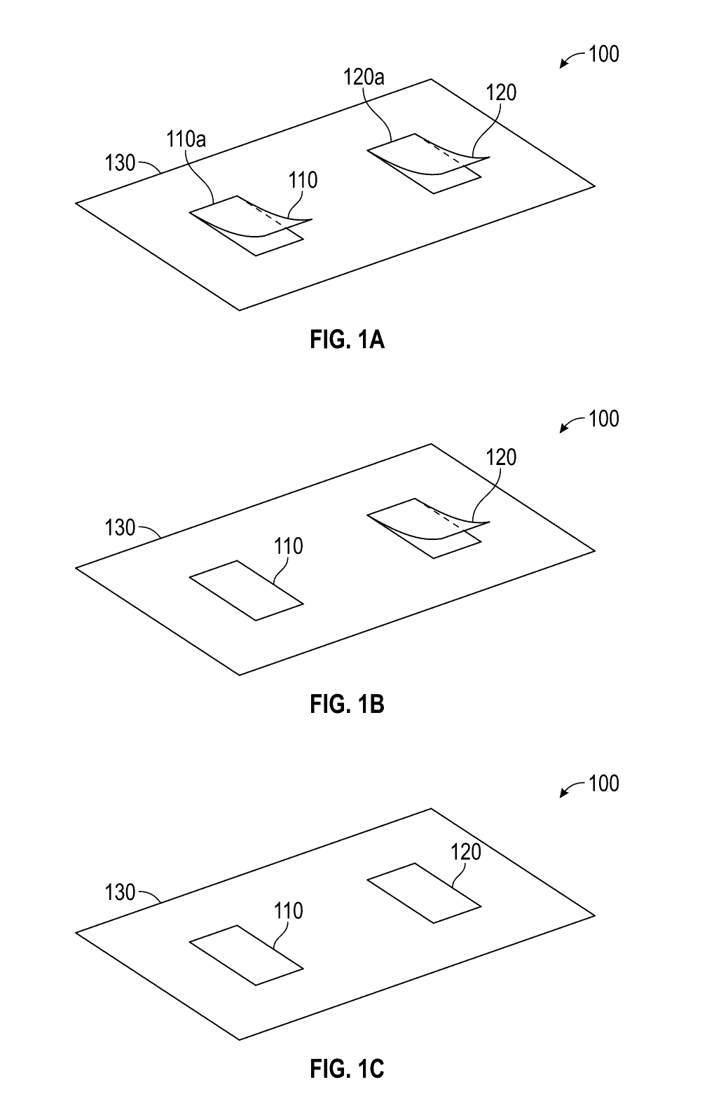

FIGS. 1A to 1C show an exemplary temperature tag 100 in accordance with some embodiments. The temperature tag 100 may include a first cantilever 110 and a second cantilever 120, each having ends 110a, 120a attached to substrate 130. The first cantilever 110 and the second cantilever 120 can be configured to transform in shape when exposed to a temperature equal to or above their respective transformation temperatures.

The first cantilever 110 and the second cantilever 120 may have a first shape (curved shape) as shown in FIG. 1A at an initial state (for example, room temperature). When the temperature tag 100 is exposed to a temperature above the transformation temperature (austenite transformation temperature) of the first cantilever 110 but below the transformation temperature (austenite transformation temperature) of the second cantilever 120, the first cantilever 110 may transform to a second shape (straight shape) while the second cantilever 120 remains unchanged in shape as shown in FIG. 1B.

When the temperature tag 100 is exposed to a temperature above the transformation temperature (austenite transformation temperature) of the first cantilever 110 and above the transformation temperature (austenite transformation temperature) of the second cantilever 120, both cantilevers 110, 120 may transform to a second shape (straight shape) as shown in FIG. 1C.

Upon cooling, for example to the initial state, the cantilevers 110,120 may remain in their second shape. Therefore, by observing the shape of the cantilevers 110,120, it can be determined whether the temperature tag 100 has been exposed to temperatures above the respective transformation temperatures of the cantilevers 110, 120. For example, if one cantilever is curved and the other is straight, the temperature tag 100 can be understood to have been exposed to a temperature above the austenite transformation temperature of the straight cantilever but below the austenite transformation temperature of the curved cantilever.

Upon further cooling to temperatures below the respective martensite transformation temperatures of the cantilevers 110, 120, the cantilevers can be restored to the first shape (curved shape) for further use by manually deforming the straight cantilevers into curved shape in the martensite phase.

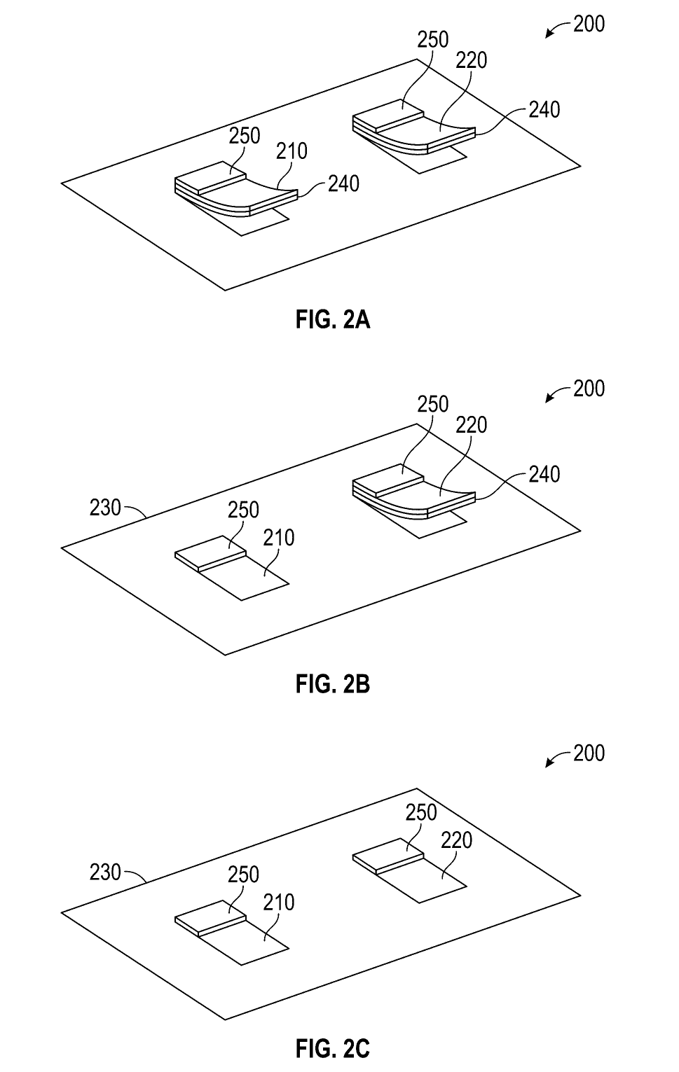

FIGS. 2A to 2C show another exemplary temperature tag 200 in accordance with some embodiments. The temperature tag 200 may include a first cantilever 210 and a second cantilever 220. The first cantilever 210 and the second cantilever 220 may include a film component layer 240 on surfaces facing the substrate 230. At an initial state (for example, room temperature), the film component layer 240 can apply a compressive force to bias the cantilevers 210, 220 in a first shape (curved shape) as shown in FIG. 2A. The temperature tag 200 may further include a piezoelectric element 250 on a surface of each cantilever opposite the substrate 230 as shown in FIG. 2A.

When the temperature tag 200 is exposed to a temperature above the transformation temperature (austenite transformation temperature) of the first cantilever 210 but below the transformation temperature (austenite transformation temperature) of the second cantilever 220, the first cantilever 210 may transform to a second shape (straight shape) by overcoming compressive forces of the film component layer 240, while the second cantilever 220 remains unchanged in shape as shown in FIG. 2B. When the temperature tag 200 is exposed to a temperature above the transformation temperature (austenite transformation temperature) of the first cantilever 210 and above the transformation temperature (austenite transformation temperature) of the second cantilever 220, both cantilevers 210, 220 may transform to a second shape (straight shape) by overcoming compressive forces of their respective film component layers 240 as shown in FIG. 2C.

Upon cooling, for example to the initial state, the cantilevers 210, 220 may remain in their second shape. Upon further cooling to temperatures below the respective martensite transformation temperatures of the cantilevers 210, 220, the cantilevers transform to the first shape (curved shape) by giving in to the compressive forces of the film component layer 240. Therefore, the film component layer 240 can “reset” the temperature tag for subsequent usage without having to manually deform the cantilevers.

During the shape transformations as described, the piezoelectric element 250 can sense the shape transformations as they occur. Therefore, exposure of the temperature tag 200 to temperatures equal to or above the transformation temperatures of the cantilevers 210, 220 can be detected in real-time.

### Methods of Making Temperature Tag

A method of making a temperature tag can include:

depositing a layer of shape memory material on a surface of a substrate, the layer of shape memory material having a graded composition along a length, a breadth, a diagonal, or a combination thereof, of the substrate; and

removing one or more portions of the substrate to form one or more cantilevers comprising the shape memory material and having at least one end attached to an unremoved portion of the substrate. In some embodiments, the method further includes removing one or more portions of the layer of shape memory material overlying unremoved portions of the substrate, for example, portions of the shape memory material that do not form part of the one or more cantilevers.

The shape memory material can be a shape memory alloy having an austenite transformation temperature and a martensite transformation temperature that is lower than the austenite transformation temperature. In some embodiments, the method of making the temperature tag further includes deforming the one or more cantilevers into a first shape before exposure to a temperature equal to or above the austenite transformation temperature. The deforming may be achieved mechanically, for example, by bending the one or more cantilevers.

In some embodiments, the method of making the temperature tag further includes cleaning the surface of the substrate before depositing the layer of shape memory material. The cleaning may for example include ultrasonic cleaning.

In some embodiments, the method of making the temperature tag further includes forming a film component layer on the surface of the substrate before depositing the layer of shape memory material, wherein the film component layer is attached to the one or more cantilevers after removing the one or more portions of the substrate. The film component layer, as described above, can apply a compressive force to deform the cantilever to a first shape (for example, a curved shape). The film component layer may be formed by various methods including oxidizing the surface of the substrate, depositing an oxide film on the surface of the substrate, or both. The film component layer may include silicon dioxide, tetraethylorthosilicate (TEOS) oxide, or any combination thereof. In some examples, the substrate is silicon and at least one surface of the substrate is thermally oxidized to form a silicon dioxide film component layer. The surface of the film component layer may be cleaned before depositing the layer of the shape memory material. The cleaning may for example include ultrasonic cleaning.

In some embodiments, the method of making the temperature tag further includes disposing a piezoelectric element on a surface of each cantilever, the piezoelectric element overlying the end of the cantilever that is attached to the unremoved portion of the substrate and a portion of the cantilever extending from the end. As described above, when the cantilever transforms in shape during temperature fluctuations, the shape transformation exerts a tensile stress on the piezoelectric element in the longitudinal direction, thereby allowing sensing of the shape transformation, and hence exposure of the temperature tag to a temperature equal to or above the transformation temperature of the cantilever.

In some embodiments, the shape memory material in at least two cantilevers have different compositions. In some embodiments, the shape memory material in the at least two cantilevers have different austenite transformation temperatures, martensite transformation temperatures, or both. The shape memory material in the at least two cantilevers may alternatively have the same composition, or the same austenite transformation temperature and martensite transformation temperature. As described above, the composition of the shape memory material can determine the transformation temperature of each associated cantilever. As such, a temperature tag may include a plurality of cantilevers made of shape memory materials with different compositions, such that the tag can detect exposures to temperatures that exceed the respective transformation temperature of each cantilever. A history of exposures of the temperature tag to different predetermined temperatures can therefore be determined.

In some embodiments, the shape memory material includes a shape memory alloy having at least two metals. In some embodiments, the shape memory alloy is Ag—Cd, Au—Cd, Cu—Sn, Cu—Zn, In—Tl, Ni—Al, Ti—Ni, Ti—Pd, Fe—Pt, Fe—Pd, Mn—Cu, Cu—Al—Ni, Cu—Au—Zn, Cu—Zn—Si, Cu—Zn—Sn, Cu—Zn—Al, Cu—Zn—Ga, Ti—Ni—Zr, Ni—Mn—Al, Cu—Al—Mn, Fe—Mn—Si, Fe—Ti—Ni, Ti—Nb—Ta, Ti—Ni—Zr—Nb, or any combination thereof.

In some embodiments, the layer of shape memory shape memory material includes a two-component alloy. In some embodiments, the two-component alloy is Ag—Cd, Au—Cd, Cu—Sn, Cu—Zn, In—Tl, Ni—Al, Ti—Ni, Ti—Pd, Fe—Pt, Fe—Pd, Mn—Cu, or any combination thereof. In some embodiments, the two-component alloy is Ti—Ni alloy.

In some embodiments, the layer of shape memory material includes a three-component alloy. In some embodiments, the three-component alloy is Cu—Al—Ni, Cu—Au—Zn, Cu—Zn—Si, Cu—Zn—Sn, Cu—Zn—Al, Cu—Zn—Ga, Ti—Ni—Zr, Ni—Mn—Al, Cu—Al—Mn, Fe—Mn—Si, Fe—Ti—Ni, Ti—Nb—Ta, or any combination thereof. In some embodiments, the three-component alloy is Ti—Ni—Zr.

In some embodiments, the layer of shape memory material includes a four-component alloy. In some embodiments, the four-component alloy is Ti—Ni—Zr—Nb.

The substrate can be made of any material that can support the one or more cantilevers. In some embodiments, the substrate includes silicon.

The method of making the temperature tag, as described above, includes removing one or more portions of the substrate underlying the layer of shape memory material to form one or more cantilevers. The removing, in some embodiments, includes wet etching, electrolytic etching, or any combination thereof.

Another method of making a temperature tag can include:

depositing a layer of shape memory material on a surface of a substrate;

annealing at least two portions of the layer of shape memory material under different conditions so that at least two portions of the layer of shape memory material have different transformation temperatures; and

removing one or more portions of the substrate underlying annealed portions of the layer of shape memory material, such that the annealed portions form one or more cantilevers having at least one end attached to an unremoved portion of the substrate.

The shape memory material may be a shape memory alloy as described above. The layer of shape memory material may have a substantially uniform composition across the surface of the substrate. The method of making the temperature tag may further include deforming the one or more cantilevers into a first shape before exposure to a temperature equal to or above the austenite transformation temperature, as described above. The deforming may include bending the one or more cantilevers, or as described above.

The surface of the substrate may be cleaned before depositing the layer of shape memory material. The cleaning of the surface of the substrate may include ultrasonic cleaning.

The method of making the temperature tag may further include forming a film component layer on the surface of the substrate before depositing the layer of shape memory material, as described above. When the one or more portions of the substrate are removed to form the one or more cantilevers, the film component layer remains attached to the one or more cantilevers. The film component layer, including the forming of the film component layer, suitable materials that make up the film component layer, and how the film component layer interacts with the one or more cantilevers, may be as described above. The surface of the film component layer may be cleaned before depositing the layer of shape memory material. The cleaning may include ultrasonic cleaning.

The method of making the temperature tag may further include disposing a piezoelectric element on a surface of each cantilever, as described above.

The annealing of the at least two portions of the layer of shape memory material may include laser irradiation annealing. The annealing of the at least two portions of the layer of shape memory material may be performed under different conditions, resulting in the at least two portions having different austenite transformation temperatures, different martensite transformation temperatures, or both. In some embodiments, the annealing of the at least two portions of the layer of shape memory material under different conditions may include annealing for different time periods. In some embodiments, the annealing of the at least two portions of the layer of shape memory material under different conditions may include annealing at different temperatures.

The layer of shape memory material may include a shape memory alloy having at least two metals, as described above. For example, the shape memory material may include a two-component alloy as described above, a three-component alloy as described above or a four-component allow as described above.

The substrate may be as described above, and may for example include silicon. The removing of the one or more portions of the substrate to form the one or more cantilevers may be as described above, and can for example include wet etching, electrolytic etching, or any combination thereof.

### Methods of Preparing a Layer of Shape Memory Material Having a Graded Composition

A method of preparing a layer of shape memory material can include:

depositing two or more sub-layers of components on a substrate to form the layer of shape memory material, at least two of the sub-layers having different components;

wherein at least one of the two or more sub-layers has a graded thickness along a length, a breadth, a diagonal, or a combination thereof, of the substrate.

In some embodiments, the two or more sub-layers are formed continuously over the substrate. In some embodiments, the two or more sub-layers are formed on one or more discrete portions over the substrate.

Where a sub-layer of component is formed with a graded thickness across the substrate, the amount of the component may accordingly vary across the substrate. Therefore, a combination of one or more sub-layers of components with graded thicknesses can result in a layer of shape memory material having different amounts of each component across the substrate, for example, in a graded fashion. In some embodiments, the layer of shape memory material has a graded composition along a length, a breadth, a diagonal, or a combination thereof, of the substrate. The sub-layers may be arranged in any order and can for example be arranged in alternating sub-layers of different components. The number of sub-layers and the thickness of each sub-layer can vary, depending on the number of components that form the shape memory material, the desired thickness of the shape memory material, or the degree of composition variation of the components across the substrate. For example, the number of sub-layers will increase if there are more components that make up the shape memory material. In another example, the number of sub-layers will increase or the thickness of the sub-layers will increase if the layer of shape memory material is desired to have a large thickness. In a further example, the thickness of each sub-layer will increase or decrease more gradually across the substrate if the amount of the component is desired to vary to a smaller degree across the substrate. In some embodiments, the number of sub-layers is 2 to 100. There can also be more than 100 layers. For example, the number of sub-layers can be 2, 10, 20, 30, 40, 50, 60, 70, 80, 90, 100, 110, 120, 130, 140, 150 or a number between any two of these values.

The thickness (that is, total thickness of all component sub-layers that make up the layer of shape memory material) of the layer of shape memory material can vary. In some embodiments, the layer of shape memory material has a thickness of about 0.2 nm to 1500 nm. In some embodiments, the layer of shape memory material has a thickness of about 0.2 nm to 150 nm. In some embodiments, the layer of shape memory material has a thickness of about 0.2 nm to 10 nm. For example, the layer of shape memory material can have a thickness of about 0.1 nm, about 0.5 nm, about 1 nm, about 2 nm, about 3 nm, about 4 nm, about 5 nm, about 6 nm, about 7 nm, about 8 nm, about 9 nm, about 10 nm, about 20 nm, about 40 nm, about 60 nm, about 80 nm, about 100 nm, about 120 nm, about 140 nm, about 160 nm, about 180 nm, about 200 nm, about 400 nm, about 600 nm, about 800 nm, about 1000 nm about 1200 nm, about 1500 nm, or a thickness between any two of these values.

The two or more sub-layers of components can form a multi-component shape memory alloy. In some embodiments, the two or more sub-layers of components can form a two-component shape memory alloy. The two-component shape memory alloy can for example be Ag—Cd, Au—Cd, Cu—Sn, Cu—Zn, In—Tl, Ni—Al, Ti—Ni, Ti—Pd, Fe—Pt, Fe—Pd, Mn—Cu, or any combination thereof. In some embodiments, the two or more sub-layers of components can form a three component shape memory alloy. The three-component shape memory alloy can for example be Cu—Al—Ni, Cu—Au—Zn, Cu—Zn—Si, Cu—Zn—Sn, Cu—Zn—Al, Cu—Zn—Ga, Ti—Ni—Zr, Ni—Mn—Al, Cu—Al—Mn, Fe—Mn—Si, Fe—Ti—Ni, Ti—Nb—Ta, or any combination thereof. In some embodiments, the two or more sub-layers of components can form a four-component shape memory alloy. The four-component shape memory alloy can for example be Ti—Ni—Zr—Nb.

The two or more sub-layers of components can be formed on the substrate or over an underlying sub-layer, for example, by sputtering. In some embodiments, two or more sub-layers of components can be formed on the substrate by combinatorial sputtering.

Another method of preparing a layer of shape memory material may include:
depositing two or more layers of components on a substrate to form the layer of shape memory material, each of the two or more layers having different components; and
annealing at least two portions of the layer of shape memory material under different conditions so that at least two portions of the layer of shape memory material have different austenite transformation temperature, martensite transformation temperature, or both.

In some embodiments, the annealing includes laser irradiation annealing. In some embodiments, annealing the at least two cantilevers under different conditions includes annealing each of the at least two portions for different time periods. By adjusting the annealing time of the different portions of the layer, the transformation temperature for each portion in the layer can be varied.

In some embodiments, annealing the at least two cantilevers under different conditions includes annealing each of the at least two portions at different temperatures. By adjusting the annealing temperature of the different portions of the layer, the transformation temperature for each portion in the layer can be varied.

In some embodiments, the two or more sub-layers of components are formed continuously over the substrate. In some embodiments, the two or more-sub-layers of components are formed in discrete portions over the substrate. In some embodiments, the layer of shape memory material has a graded austenite transformation temperature, a graded martensite transformation temperature, or both, along a length, a breadth, a diagonal, or a combination thereof, of the substrate. The two or more layers may be arranged in any order and can for example be arranged in alternating sub-layers of different components. The number of sub-layers and the thickness of each sub-layer can vary, depending on the number of components that form the shape memory material, and the desired thickness of the shape memory material. For example, the number of sub-layers will increase if there are more components that make up the shape memory material. In another example, the number of sub-layers will increase or the thickness of the sub-layers will increase if the layer of shape memory material is desired to have a large thickness. In some embodiments, the number of sub-layers is 2 to 100. There can also be more than 100 layers. For example, the number of sub-layers can be 2, 10, 20, 30, 40, 50, 60, 70, 80, 90, 100, 110, 120, 130, 140, 150 or a number between any two of these values. The thickness of each of the sub-layers in the layer of shape memory material can vary. In some embodiments, each of the sub-layers has a thickness of about 0.1 nm to 10 nm. For example, each of the sub-layers can have a thickness of about 0.1 nm, about 0.5 nm, about 1 nm, about 2 nm, about 3 nm, about 4 nm, about 5 nm, about 6 nm, about 7 nm, about 8 nm, about 9 nm, about 10 nm, or a thickness between any two of these values.

The two or more sub-layers of components may be as described above, and can for example form a multi-component shape memory alloy. For example, the two or more sub-layers of components can form a two-component shape memory alloy as described above, a three-component shape memory alloy as described above, or a four-component shape memory alloy as described above.

### Methods of Using Temperature Tag

A method of using a temperature tag may include: attaching the temperature tag to an object, the temperature tag comprising one or more cantilevers, each having at least one end attached to a substrate, wherein the cantilever comprises a shape memory material having at least one transformation temperature, and the cantilever is configured to transform in shape when exposed to a temperature equal to or above the at least one transformation temperature; and

reading the temperature tag after a period of time to determine if the object has been exposed to a predetermined temperature associated with each cantilever, the predetermined temperature being equal to or above the at least one transformation temperature of that cantilever.

In some embodiments, reading the temperature tag includes observing a change in each cantilever's shape on the temperature tag; and correlating the change of the cantilever's shape with the transformation temperature at which the change occurs. In some embodiments, the change in the shape of the cantilever is detected visually. In some embodiments, the change in the shape is detected by a machine or camera system. For example, if a cantilever having a transformation temperature (for example, austenite transformation temperature) of about 80° C. is observed to be in the second shape (original shape or straight shape) and another cantilever having a transformation temperature (for example, austenite transformation temperature) of about 100° C. is observed to be in the first shape (deformed shape or curved shape) when the tag is read, it can be understood that the tag has been exposed to a temperature equal to or above 80° C. but lower than 100° C.

In some embodiments, each cantilever has a piezoelectric element overlying the end of the cantilever that is attached to the substrate and a portion of the cantilever extending from the end, and the change in the shape of each of the cantilevers is converted into an electromotive force by the piezoelectric element. The electromotive force can be detected by detecting a voltage across the piezoelectric element. The piezoelectric element can be coupled to a wireless communication network such as ZigBee® (a registered trademark of ZigBee Alliance, Calif., USA) which can communicate the detected signals or information to a user's device.

In some embodiments, the piezoelectric element is PVDF (polyvinylidene difluoride), BaTiO₃, PbPO₃, KNbO₃, LiNbO₃, LiTiO₃, LiTaO₃, Ba₂NaNb₅O₅, Pb₂KNb₅O₁₅, AN, PZT (lead zirconate titanate), ZnO, or any combination thereof.

### EXAMPLES

### Example 1

### Temperature Tag with Ti—Ni—Zr Shape Memory Material Having Graded Thicknesses of Component Sub-Layers

A layer of Ti—Ni—Zr shape memory material may be formed on a surface of a silicon substrate. The silicon substrate can have an equilateral triangle shape, measuring 10 mm in length on each side.

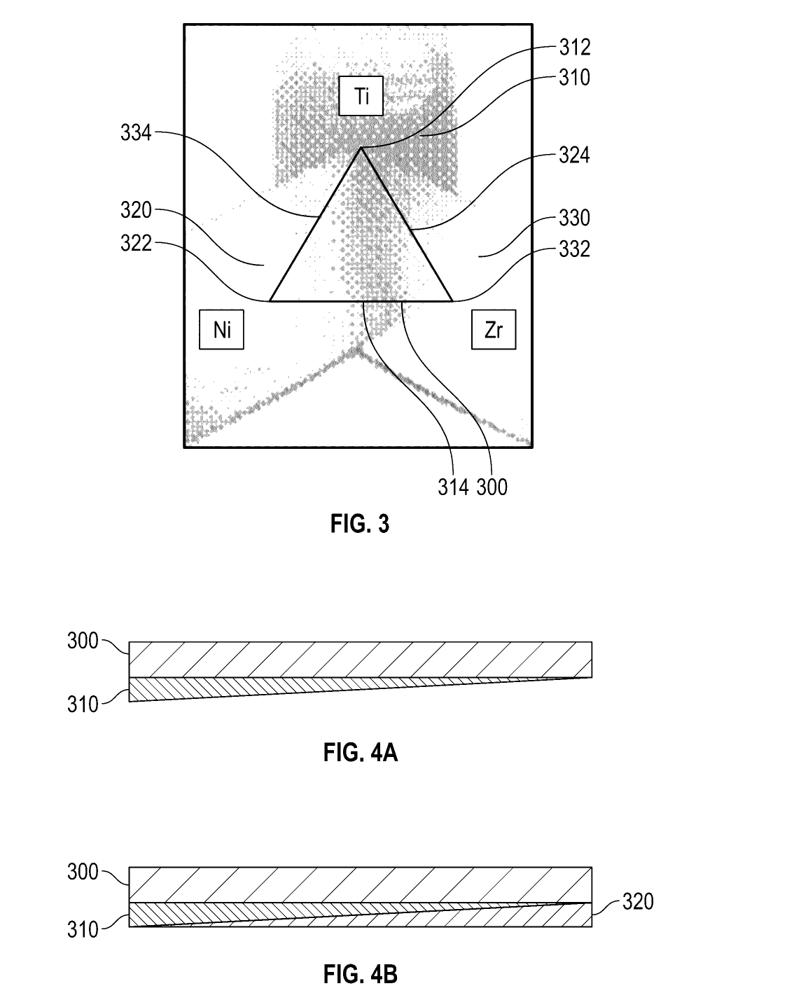

FIG. 3 shows an exemplary layer of Ti—Ni—Zr shape memory material that can be formed on a substrate 300. The Ti—Ni—Zr shape memory material can be formed by depositing a titanium (Ti) sub-layer 310, a nickel (Ni) sub-layer 320 and a zirconium (Zr) sub-layer 330 on the substrate 300 using combinatorial sputtering. The substrate surface may be ultrasonically cleaned before depositing the shape memory material. The depositing can be such that each of the sub-layers have varying thicknesses across the substrate 300 to result in the layer of shape memory material having graded compositions of Ti, Ni and Zr components across the substrate 300. For example, the Ti sub-layer 310 can be deposited in decreasing thickness from vertex 312 towards side edge 314. Likewise, the Ni sub-layer 320 can be deposited in decreasing thickness from vertex 322 towards side edge 324, and the Zr sub-layer 330 can be deposited in decreasing thickness from vertex 332 towards side edge 334.

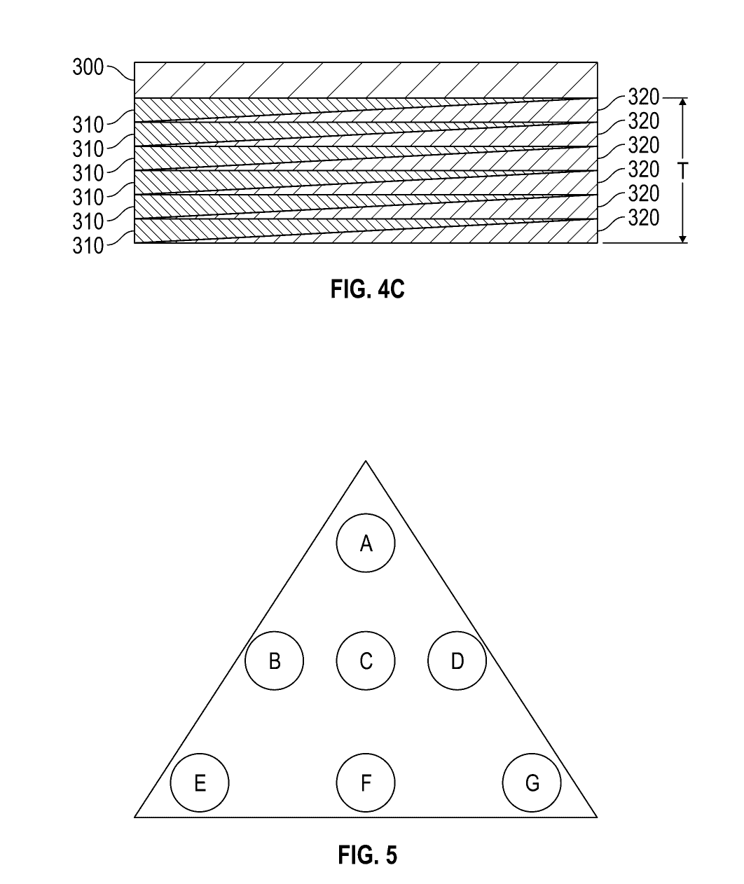

FIGS. 4A to 4C show an exemplary side edge 334 of the substrate 300 at various stages of material deposition. The Ti sub-layer 310 may have a graded thickness that decreases in one direction along the side edge 334 as shown in FIG. 4A. The Ni sub-layer 320 may have a graded thickness that increases in the same direction along the side edge 334 as shown in FIG. 4B.

The depositing of the Ti sub-layer 310, the Ni sub-layer 320 and the Zr sub-layer 330 may be repeated until the resulting layer of shape memory material has a desired thickness T, as shown in FIG. 4C (Zr sub-layer 330 is not visible in FIG. 4C as FIG. 4C shows the side edge of the substrate between the Ti vertex and Ni vertex). The thickness of the resulting layer of shape memory material can, for example, be 10 nm.

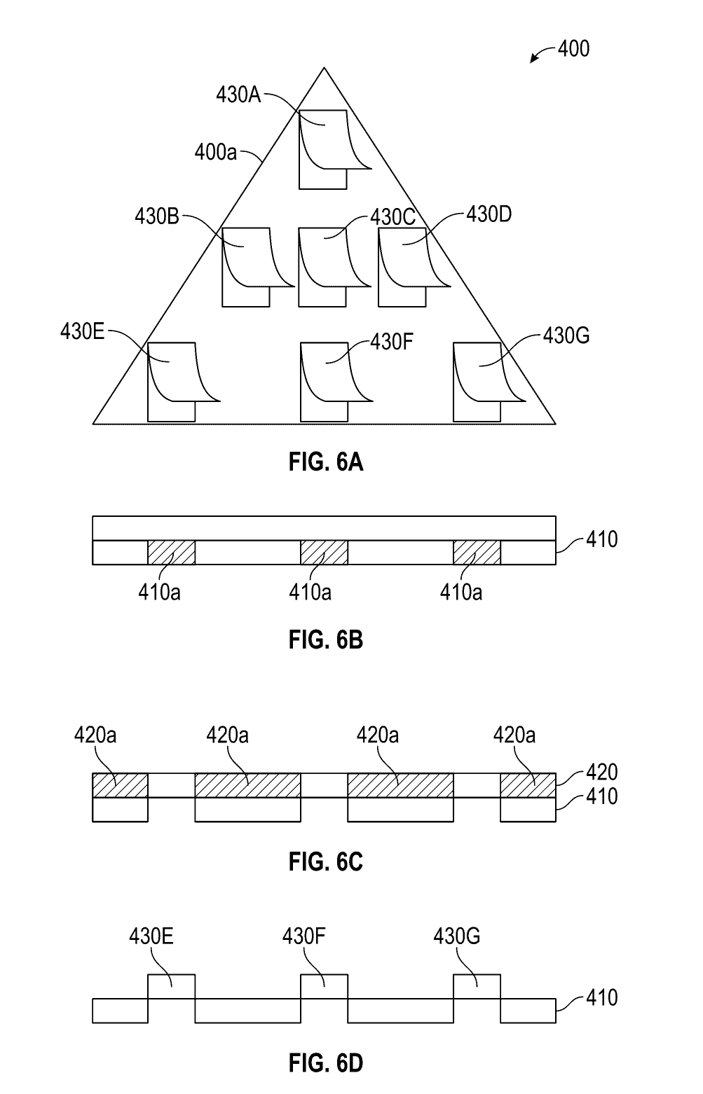

FIG. 5 shows exemplary Parts A to G of the shape memory material having varying composition ratios of Ti, Ni and Zr. Compositions of Ti, Ni and Zr at Parts A to G may be such that they have different austenite transformation temperatures. The austenite transformation temperatures of Parts A to G may be configured as T_{A}° C.=100° C., T_{B}° C.=110° C., T_{C}° C.=120° C., T_{D}° C.=130° C., T_{E}° C.=140° C., T_{F}° C.=150° C. and T_{G}° C.=160° C.

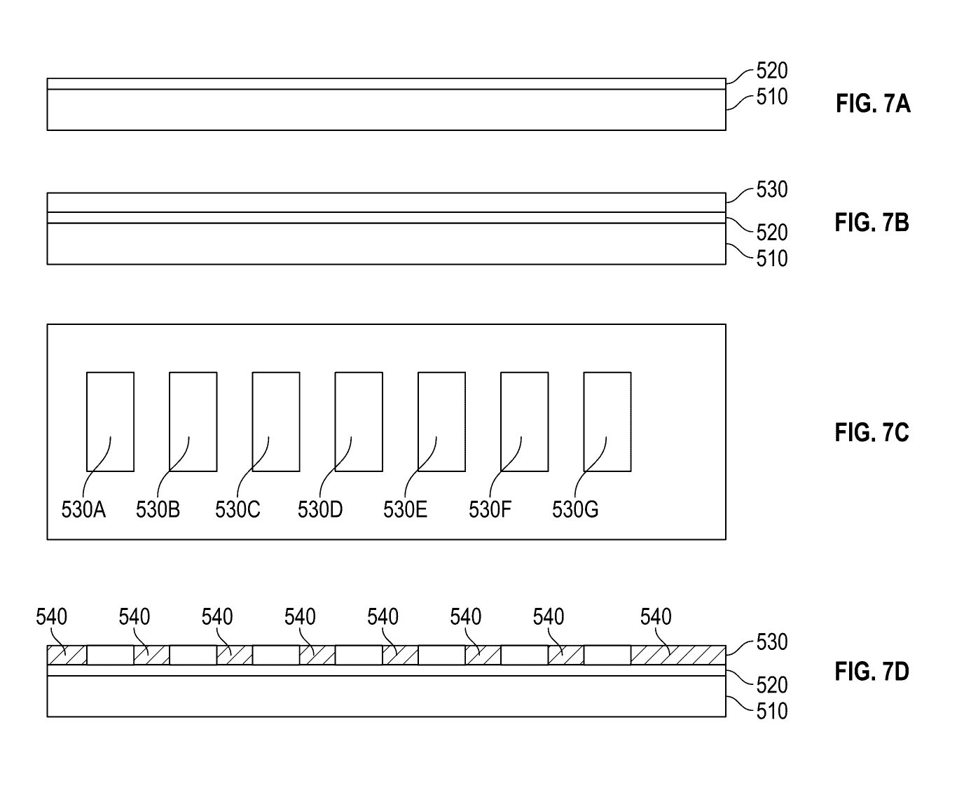

The substrate-supported shape memory material may be further processed to form a temperature tag 400 as shown in FIG. 6A. Referring to FIG. 6B which shows a side edge 400a of the temperature tag 400 before forming the cantilevers, portions 410a of the substrate 410 underlying cantilevers 430A to 430G, may be removed by wet etching to form the structure as shown in FIG. 6C. Portions 420a of the shape memory material 420 overlying unremoved portions of the substrate (portions of the shape memory material that do not form part of the cantilevers) may further be removed by wet etching to form the structure as shown in FIG. 6D. FIG. 6D shows a side view of cantilevers 430E, 430F, 430G as viewed from side edge 400a. Each resulting cantilever 430A to 430G may have one end attached to an unremoved portion of the substrate. The cantilevers may be manually deformed to result in the temperature tag 400 as shown in FIG. 6A.

When in use, the temperature tag can indicate whether the surrounding temperature has exceeded one or more predetermined temperatures by visually observing the cantilevers on the temperature tag. For example, when the surrounding temperature increases to about 120° C. and then cools to room temperature, cantilevers 430A, 430B and 430C will be straight while the remaining cantilevers remain curved.

In order to re-use the temperature tag, the cantilevers can be exposed to temperatures below their respective martensite transformation temperatures such that the straight cantilevers can be manually deformed to the initial curved shape.

### Example 2

### Temperature Tag with Ti—Ni Shape Memory Material Having Annealed Component Sub-Layers

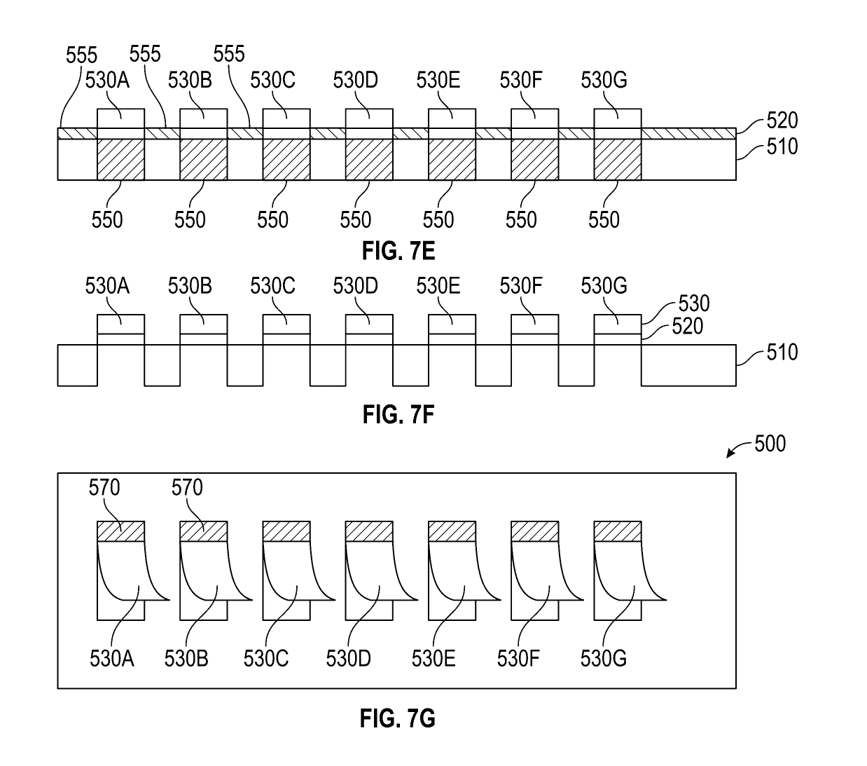

FIGS. 7A to 7F show a temperature tag 500 at various stages of making. A layer of Ti—Ni shape memory material 520 may be formed on a surface of a silicon substrate 510. The silicon substrate 510 can have a rectangular shape, measuring 15 mm in length and 5 mm in breadth. FIG. 7A shows a side view of the silicon substrate 510. The surface of the silicon substrate may be thermally oxidized to form a film component layer 520. The thermally oxidized surface may then be ultrasonically cleaned.

The Ti—Ni shape memory material can be formed by depositing a titanium (Ti) sub-layer and a nickel (Ni) sub-layer on the thermally oxidized substrate using combinatorial sputtering. The resulting layer of shape memory material 530 may have a uniform thickness across the substrate 510 as shown in FIG. 7B.

The surface of the shape memory material 530 can be segmented into parts 530A to 530G as shown in FIG. 7C. Portions 540 of the shape memory material 530 may be removed by wet etching leaving behind Parts 530A to 530G as shown in FIG. 7E, and exposing portions of the film component layer 520. Parts 530A to 530G of the Ti—Ni—Zr shape memory material 530 may be annealed under different conditions to result in different transformation temperatures T_{A}° C., T_{B}° C., T_{C}° C., T_{D}° C., T_{E}° C., T_{F}° C. and T_{G}° C., respectively. The annealing can be carried out using laser irradiation such that each of the Parts 530A to 530G is exposed to different irradiation temperature and/or different annealing time period. The austenite transformation temperatures of cantilevers 530A to 530G may be configured as T_{A}° C.=40° C., T_{B}° C.=45° C., T_{C}° C.=50° C., T_{D}° C.=55° C., T_{E}° C.=60° C., T_{F}° C.=65° C. and T_{G}° C.=70° C., respectively.

Portions 550 of the substrate 510 underlying Parts 530A to 530G may be removed by wet etching, followed by removal of portions 555 of the film component layer 520 overlying unremoved portions of the substrate to result in the structure as shown in FIG. 7F. The resulting structure forms a temperature tag having cantilevers 530A to 530G that include a film component layer 520 on the shape memory material 530. As the film component layer exerts a compressive force on the shape memory material, the resulting cantilevers are biased in a curved as shown in FIG. 7G. Piezoelectric elements 570 may be disposed on a surface of each cantilever as shown in FIG. 7F. The piezoelectric elements 570 can be coupled to a wireless communication network such as ZigBee® (a registered trademark of ZigBee Alliance, Calif., USA) which can communicate temperature changes detected by the temperature tag to a user's device.

When in use, the temperature tag 500 can indicate whether the surrounding temperature has exceeded one or more predetermined temperatures. For example, when the surrounding temperature increases to about 60° C. and then cools to room temperature, cantilevers 530A, 530B, 530C and 530D will be straight while the remaining cantilevers remain curved. As the cantilevers transform from the curved shape to the straight shape during the temperature increase, the piezoelectric element can detect the change in the shape of the cantilevers, and communicate the detection to a user's device in real-time.

In order to re-use the temperature tag, the cantilevers can be exposed to temperatures below their respective martensite transformation temperatures and the compressive force exerted by the film component layer can deform the straight cantilevers to the initial curved shape.

The temperature tags as described in the Examples above and in the disclosed embodiments can have applications in monitoring exposure of temperature sensitive products such as pharmaceutical drugs, perishable food items and electronic devices, to surrounding temperature changes. The temperature tags can be attached to the products or to the packaging of the products.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” and so on.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, and so on.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, and so on.). In those instances where a convention analogous to “at least one of A, B, or C, and so on.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, and so on.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and allowing the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A temperature tag comprising:
one or more cantilevers, each having at least one end attached to a substrate,
wherein the cantilever comprises a shape memory material having at least one transformation temperature, and the cantilever is configured to transform from a first shape to a second shape when exposed to a temperature equal to or above the at least one transformation temperature.

2. The temperature tag of claim 1, wherein the shape memory material is a shape memory alloy, and the at least one transformation temperature comprises an austenite transformation temperature and a martensite transformation temperature that is lower than the austenite transformation temperature.

3. The temperature tag of claim 2, wherein the cantilever transforms from the first shape to the second shape after exposure to a temperature equal to or above the austenite transformation temperature, and the cantilever remains in the second shape when it cools to a temperature below the austenite transformation temperature.

4. The temperature tag of claim 2, further comprising a film component layer on a surface of the cantilever facing the substrate, wherein the film component layer applies a compressive force to bias the cantilever in the first shape.

5. The temperature tag of claim 4, wherein the cantilever overcomes the compressive force of the film component layer to transform from the first shape to the second shape after exposure to a temperature equal to or above the austenite transformation temperature, and the cantilever remains in the second shape when it cools to a temperature above the martensite transformation temperature.

6. The temperature tag of claim 5, wherein the cantilever gives in to the compressive force of the film component layer to transform from the second shape to the first shape when it further cools to a temperature equal to or below the martensite transformation temperature.

7. The temperature tag of claim 4, wherein the film component layer is an oxide film.

8. The temperature tag of claim 1, further comprising a piezoelectric element on a surface of the cantilever opposite the substrate, the piezoelectric element overlying the end of the cantilever that is attached to the substrate and a portion of the cantilever extending from the end.

9. The temperature tag of claim 1, wherein the shape memory alloy is Ag—Cd, Au—Cd, Cu—Sn, Cu—Zn, In—Tl, Ni—Al, Ti—Ni, Ti—Pd, Fe—Pt, Fe—Pd, Mn—Cu, Cu—Al—Ni, Cu—Au—Zn, Cu—Zn—Si, Cu—Zn—Sn, Cu—Zn—Al, Cu—Zn—Ga, Ti—Ni—Zr, Ni—Mn—Al, Cu—Al—Mn, Fe—Mn—Si, Fe—Ti—Ni, Ti—Nb—Ta, Ti—Ni—Zr—Nb, or any combination thereof.

10. The temperature tag of claim 2, wherein the austenite transformation temperature of the shape memory material is about −70° C. to about 880° C.

11. The temperature tag of claim 1, wherein the first shape is a curved shape and the second shape is a straight shape.

12. The temperature tag of claim 1, wherein the shape memory material in at least two cantilevers have different compositions.

13. The temperature tag of claim 1, wherein the shape memory material in at least two cantilevers have different austenite transformation temperatures, martensite transformation temperatures, or both.

14. The temperature tag of claim 1, wherein the one or more cantilevers comprise a plurality of cantilevers arranged in an array.

15. The temperature tag of claim 1, wherein the substrate comprises silicon.

16. A method of making a temperature tag, the method comprising
depositing a layer of shape memory material on a surface of a substrate, the layer of shape memory material having a graded composition along a length, a breadth, a diagonal, or a combination thereof, of the substrate; and
removing one or more portions of the substrate to expose one or more portions of the shape memory material, wherein exposed one or more portions of the shape memory material form one or more cantilevers, each cantilever extending from an unremoved portion of the substrate.

17. The method of claim 16, wherein the shape memory material is a shape memory alloy having an austenite transformation temperature and a martensite transformation temperature that is lower than the austenite transformation temperature.

18. The method of claim 17, further comprising deforming the one or more cantilevers into a first shape before exposure to a temperature equal to or above the austenite transformation temperature.

19. The method of claim 16, further comprising forming a film component layer on the surface of the substrate before depositing the layer of shape memory material, wherein the film component layer is attached to the one or more cantilevers after removing the one or more portions of the substrate.

20. The method of claim 19, wherein forming the film component layer comprises oxidizing the surface of the substrate, depositing an oxide film on the surface of the substrate, or both.

21. The method of claim 16, further comprising disposing a piezoelectric element on a surface of each cantilever, the piezoelectric element overlying an end of the cantilever that is attached to the unremoved portion of the substrate and a portion of the cantilever extending from the end.

22. A method of making a temperature tag, the method comprising:
depositing a layer of shape memory material on a surface of a substrate;
annealing at least two portions of the layer of shape memory material under different conditions so that at least two portions of the layer of shape memory material have different transformation temperatures; and
removing one or more portions of the substrate underlying annealed portions of the layer of shape memory material, such that the annealed portions form one or more cantilevers, each cantilever extending from an unremoved portion of the substrate.

23. The method of claim 22, wherein the shape memory material is a shape memory alloy having an austenite transformation temperature and a martensite transformation temperature that is lower than the austenite transformation temperature.

24. The method of claim 23, further comprising deforming the one or more cantilevers into a first shape before exposure to a temperature equal to or above the austenite transformation temperature.

25. The method of claim 22, further comprising forming a film component layer on the surface of the substrate before depositing the layer of shape memory material, wherein the film component layer is attached to the one or more cantilevers after removing the one or more portions of the substrate.

26. The method of claim 25, wherein forming the film component layer comprises oxidizing the surface of the substrate, depositing an oxide film on the surface of the substrate, or both.

27. The method of claim 22, further comprising disposing a piezoelectric element on a surface of each cantilever, the piezoelectric element overlying an end of the cantilever that is attached to the unremoved portion of the substrate and a portion of the cantilever extending from the end.

28. The method of claim 22, wherein the annealing comprises laser irradiation annealing.

29. The method of claim 22, wherein annealing the at least two portions of the layer of shape memory material under different conditions result in the at least two portions having different austenite transformation temperatures, martensite transformation temperatures, or both.

30. A method of using a temperature tag, the method comprising:
attaching the temperature tag to an object, the temperature tag comprising one or more cantilevers, each having at least one end attached to a substrate, wherein the cantilever comprises a shape memory material having at least one transformation temperature, and the cantilever is configured to transform in shape when exposed to a temperature equal to or above the at least one transformation temperature; and
reading the temperature tag after a period of time to determine if the object has been exposed to a predetermined temperature associated with each cantilever, the predetermined temperature being equal to or above the at least one transformation temperature of that cantilever.

31. The method of claim 30, wherein reading the temperature tag comprises observing a change in each cantilever's shape on the temperature tag; and
correlating the change of the cantilever's shape with the transformation temperature at which the change occurs.

32. The method of claim 31, wherein the change in the shape of the cantilever is detected visually.

33. The method of claim 30, wherein each cantilever has a piezoelectric element overlying the end of the cantilever that is attached to the substrate and a portion of the cantilever extending from the end, and the change in the shape of each of the cantilevers is converted into an electromotive force by the piezoelectric element.
